(19) United States
(12) Patent Application Publication
(10) Pub. No.: US 2009/0236147 A1
(43) Pub. Date: Sep. 24, 2009

(54) Lubricated Diamond Bearing Drill Bit

(75) Inventors: Terry J. Koltermann, The Woodlands, TX (US); Aaron J. Dick, Houston, TX (US)

Correspondence Address: Bracewell & Giuliani LLP, P.O. Box 61389, Houston, TX, 77208-1389, US

(73) Assignee: Baker Hughes Incorporated, Houston, TX (US)

(21) Appl. No.: 12/052,627

(22) Filed: Mar. 20, 2008

(51) Int. Cl. C09K 8/035

(52) U.S. Cl. 175/65; 175/227

(57) ABSTRACT

A method for lubricating a diamond bearing system of a downhole well tool involves dispensing a polyol lubricant for the reduction of friction between the two diamond surfaces. The lubricant forms a reduced friction surface film on the diamond. The polyol lubricant may be mixed with water. The polyol lubricant may contain ethylene glycol, glycerol, or a combination with water.

### FIELD OF THE INVENTION

The present invention relates generally to a diamond bearing system in a roller cone rock bit for well drilling, and more particularly, to a lubricant in such bearing system.

### BACKGROUND OF THE INVENTION

Because of their aggressive cutting action and fast penetration rates, roller cone rock bits have been widely used for oil, gas, and geothermal drilling operations. In drilling boreholes in earthen formations by the rotary method, earth-boring bits typically employ at least one rolling cone cutter, rotatably mounted thereon. The bit is secured to the lower end of a drill string that is rotated from the surface, or the bit is rotated by a downhole motor. The cutters or cones mounted on the bit roll and slide upon the bottom of the borehole as the drill string is rotated, thereby engaging and disintegrating the earth formation material. The rolling cutters are provided with teeth that are forced to penetrate and gouge the bottom of the borehole by weight from the drill string.

As the cutters roll and slide along the bottom of the borehole, the cutters, and the shafts on which they are rotatably mounted, are subjected to large static loads from the drill string weight on the bit, and large transient or shock loads encountered as the cutters roll and slide along the uneven surface of the bottom of the borehole. Thus, rock bits are most often provided with precision-formed journal bearings and bearing surfaces that are hardened, such as through carburizing or coating, or provided with wear-resistant metal inlays.

Rock bits are also typically provided with lubrication systems to increase the drilling life of the bit. These lubrication systems typically are sealed to avoid lubricant loss and to prevent contamination of the bearings by foreign matter such as abrasive particles encountered in the borehole. A pressure compensator within the lubrication system minimizes pressure differential across the seal so that the lubricant pressure is equal to or slightly greater than the hydrostatic pressure in the annular space between the bit and the sidewall of the borehole. For examples of sealed lubricant systems, see U.S. Pat. Nos. 3,397,928; 3,476,195; and 4,061,376.

Despite these advances in bearing and lubrication technology, improvements are still sought to increase the performance of the bearing systems to thus increase the life of the drill bit. Polycrystalline diamond (PCD), for instance, has been proposed to increase the wear resistance of bearing surfaces in downhole tools. U.S. Pat. Nos. 6,068,070 and 4,738,322, among others, illustrates how this type of PCD member may be used as a bearing surface in a roller cone rock bit.

Chemical vapor deposition (CVD) is a method to place a layer of diamond on a shaft bearing surface or a cutter bearing surface of a rock bit. Unlike PCD surfaces formed under high temperatures and high pressures, CVD diamond films may be formed with a variety of different geometries and surface finishes.

Rather than a pure diamond coating, diamond like carbon coating (DLC) may be applied to the surface of a bearing member using physical vapor deposition (PVD) processes after it has been hardened and tempered. A DLC surface is a carbon coating with a mixture of sp3 and sp2 bonds between the carbon atoms and could be doped with one of more alloying element such as silicon, boron, boron nitride, and one or more refractory metallic elements, such an tantalum, titanium, tungsten, niobium, or zirconium. The designation sp3 refers to the tetrahedral bond of carbon in diamond, while the designation sp2 is the type of bond in graphite. As DLC has a certain percentage of both, its hardness is less than diamond and between diamond and graphite.

Lubricants used in diamond bearing systems of such rock bits are a critical element to the life of the rock bit. Typical drilling operations thus take place in an abrasive environment of drilling mud and rock particles, which are thousands of feet from the engineer or supervisor, who does not typically have the benefit of oil pressure gauges or temperature sensors at the bearing surfaces to be lubricated. Therefore, there is a need to develop functional fluids capable of serving as lubricant compositions for diamond bearing systems in extreme temperature and pressure environments. Such a lubricant must not break down under the temperature and pressure conditions encountered, must not generate substantial internal pressures in the bit, must enable flow through passages to the surfaces to be lubricated.

Failure of the lubrication system quickly results in failure of the rock bit as a whole. When the rock bit wears out or fails as the borehole is being drilled, it is necessary to withdraw the drill string for replacing the bit. The amount of time required to make a round trip for replacing a bit is essentially lost from drilling operations. This time can become a significant portion of the total time for completing a well, particularly as the well depths become greater and greater. The useful life of various diamond bearing surfaces is a critical consideration in light of the great expense in time and money to remove and replace the entire drilling string because of bearing failure. A successful diamond bearing lubricant should have a useful life longer than other elements of the rock bit so that premature failures of bearings do not unduly limit drilling.

A variety of lubricant compositions have been employed in standard rock bits, which do not have diamond bearing systems. Such grease compositions typically comprise a high viscosity, refined petroleum oil or mineral oil which provides the basic lubricity of the composition and may constitute about 1 to ¾ of the total grease composition. The refined hydrocarbon or mineral oil is typically thickened with a metal soap or metal complex soap, the metals being typically selected from aluminum, barium, calcium, lithium, sodium or strontium. Complex, thickened greases are well known in the art and are discussed, for example, in Encyclopedia of Chemical Technology, Kirk-Othmer, Second Edition, A. Standen, Editor, Interscience Publishers, John Wiley and Sons, Inc., New York, N.Y., 1967, pages 582-587. See also Modern Lubricating Greases, by C. J. Boner, Scientific Publications (GB) Limited, Chapter 4. U.S. Pat. No. 3,935,114, assigned to the assignee of the present invention, teaches the use of molybdenum disulfide and antimony trioxide in a lubricating grease for a journal bearing used in a drill bit. U.S. Pat. No. 5,015,401, issued May 14, 1991, and assigned to the assignee of the present invention shows a rock bit bearing grease which includes a refined petroleum or hydrocarbon oil fluid base which is thickened with an alkaline metal soap or metal soap complex and which contains as solid lubricants powdered molybdenum disulfide and calcium fluoride. Similarly, U.S. Pat. 6,056,072, issued May 2, 2000, and assigned to the assignee of the present invention is directed toward a grease composition suitable for use in rock bit bearings that can be formulated with a synthetic fluid base and thickened with specific thickener systems to produce a grease which is particularly effective for the slow speed and highly loaded bearing configurations of rolling element and journal type rock bit bearings.

Despite the success of these lubricants in standard bearing systems, these lubricants do not appear to be sufficiently effective when used in combination with a bearing system using diamond surfaces. It has been found that when two un-lubricated diamond surfaces are well polished and fit together well, the coefficient of friction is relatively high compared with the coefficient of friction in a standard lubricated bearing system. Without a lubricant, overheating of the bearing and early wear are likely to occur, as the diamond reverts to graphite above certain temperatures that are well-known in the art. A need exists, therefore, for a diamond bearing lubricant having superior lubricating properties which can be employed in lubricating the diamond bearing surfaces of bits used for drilling in abrasive, subterranean atmospheres. A need also exists for such a diamond bearing lubricant to exhibit low wear characteristics that can be used in rock bit bearings to provide extended wear life and load carrying capacity while adequately protecting diamond bearing surfaces from premature wear or failure.

Polyol liquids such as glycerol are known to be used as lubricants, but not in drill bit bearing lubrication systems. A polyol liquid is defined as an organic compound having a minimum of two hydroxyl groups. These liquids would be considered an inferior lubricant in a conventional roller cone rock bit bearing system, given the superior properties of the prior lubricants known in the art.

### SUMMARY OF THE INVENTION

The lubricant used in the sealed lubrication system comprises a polyol or combination of polyols such as ethylene glycol (1,2 ethanediol) and glycerol(1,2,3 propanetriol). In addition the lubricant used in the sealed lubrication system may also comprise one or more polyols in combination with water. Other polyols of differing molecular weights could be likewise used, depending on the desired properties of the lubricant.

### BRIEF DESCRIPTION OF THE DRAWINGS

FIG. 1 is. a sectional view of a drill bit having a lubricant system in accordance with the invention.

FIG. 2 is an enlarged sectional view of a portion on the bearing system of FIG. 1.

FIG. 3 is a graph of a series of tests that indicate friction between PCD diamond surfaces over increasing loads with different lubricants and as compared to a standard, non diamond bearing.

### DETAILED DESCRIPTION OF THE INVENTION

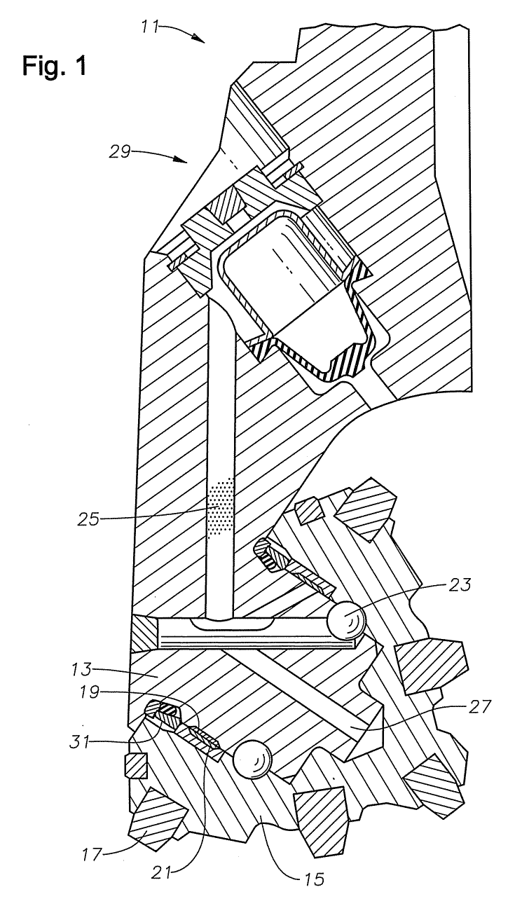

Referring to FIG. 1, the roller cone rock bit has a bit body 11 with at least one and normally three depending bearing pins 13. A cone or cutter 15 is rotatably mounted on each being pin 13. Cone 15 has a plurality of rows of cutting elements 17, which may be tungsten carbide conipacts pressed into mating holes or teeth integrally machined in cone 15. Cone 15 has an internal cavity containing a cone bearing 19 that slidingly engages a bearing pin bearing 21. Cone 15 is retained on bearing pin 13 by a plurality of locking balls 23 located in mating grooves in bearing pin 13 and the cavity of cone 15.

Bearings 19, 21 are supplied with a lubricant 25 from a lubricant reservoir and pressure compensator 29. Lubricant passages 27 extend from pressure compensator 29 to bearings 19, 21. A seal assembly 31 is disposed adjacent to the base of bearing pin 13 to seal lubricant 25 within and debris out of bearings 19, 21. Seal assembly 31 may be a variety of types.

Each of the bearings 19, 21 contains a diamond layer. The term “diamond” refers to super hard layers of diamond or diamond-like material, however formed, including vapor deposition, such as by CVD (chemical vapor deposition), PVD (physical vapor deposition), or by high temperature, high pressure processes, which form PCD (polycrystalline diamond). The diamond may be formed directly on bearing pin 13 and the cavity of cone 15, or it may be formed on carbide components, which are then fixed to bearing pin 13 and cone 15.

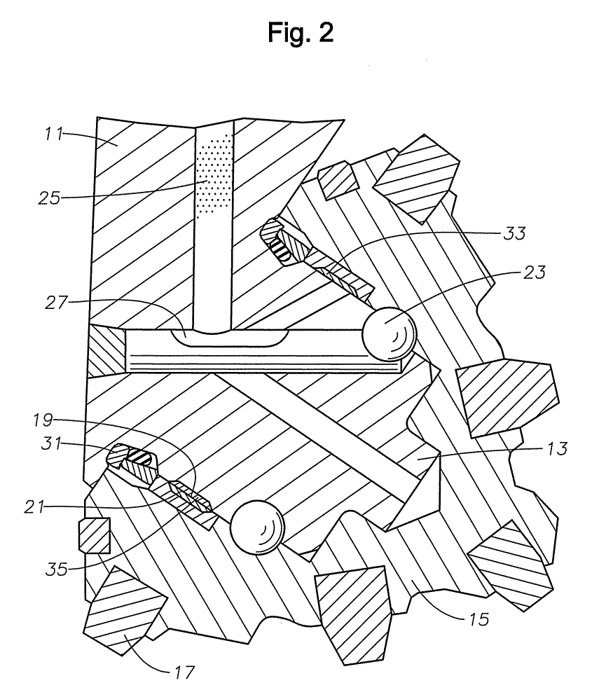

Referring to FIG. 2, in one embodiment, the diamond material for cone bearing 19 comprises separate pads 33 mounted in shallow recesses circumferentially spaced around the inner diameter of a hard metal sleeve, which in turn is mounted in the cavity of cone 15 for rotation with cone 15. Each pad 33 comprises a carbide substrate with a layer of diamond formed thereon. Pads 33 could be replaced with a continuous ring. The diamond material for bearing pin bearing 21 comprises a plurality of pads 35 located in shallow recesses formed on the lower side of bearing pin 13.

If the diamond material is PCD, it would be formed at high pressure and temperature conditions under which the diamond material is thermodynamically stable. For example, a PCD layer suitable for cone and bearing pin bearings 19, 21 may be made by forming a refractory metal container or can to the desired shape, and then filling the can with diamond powder to which a small amount of metal material (commonly cobalt, nickel, or iron) has been added. The powder may be capped with a cemented carbide blank or substrate. The container is then sealed to prevent any contamination. Next, the sealed can is surrounded by a pressure transmitting material, which is generally salt, boron nitride, graphite or similar material. This assembly is then loaded into a high-pressure and temperature cell. The cell is compressed until the desired pressure is reached and then heat is supplied via a graphite-tube electric resistance heater. Temperatures in excess of 1350° C. and pressures in excess of 50 kilobars are common. At these conditions, the added metal is molten and acts as a reactive liquid phase to enhance sintering of the diamond material. After a few minutes, the conditions are reduced to room temperature and pressure. The PCD member is then broken out of the cell and can be finished to final dimensions through grinding or shaping.

If the diamond material is formed by a CVD process, in one method, a free standing layer of diamond film is formed by CVD, which is a conventional process. This may be accomplished by forming a layer of diamond film on a substrate, such as tungsten carbide, and then removing the diamond film from the substrate. Alternately, the diamond film could remain on the substrate. The diamond film is then mounted to the lower side of bearing pin 13 and/or to the cavity of cone 15 by means of brazing or soldering. CVD diamond films may be formed with a variety of different geometries and surface finishes.

Rather than a pure diamond coating, a diamond like coating (DLC) can be applied to the surface of a steel bearing member such as sleeves for placement on bearing pin 13 or in the cavity of cone 15, after the sleeves have been hardened and tempered. DLC is a PVD carbon coating with a mixture of sp3 and sp2 bonds between the carbon atoms and could be doped with one of more alloying element such as silicon, boron, boron nitride, and one or more refractory metallic elements, such an tantalum, titanium, tungsten, niobium, or zirconium. The designation sp3 refers to the tetrahedral bond of carbon in diamond, while the designation sp2 is the type of bond in graphite. As DLC has a certain percentage of both, its hardness is less than diamond and between diamond and graphite.

Lubricant 25 comprises a polyol liquid or a combination of polyol liquids mixed with water or in the absence of water. The polyol consists of a chain hydrocarbon with hydroxyl groups attached to the carbon atoms such as glycerol or ethylene glycol.

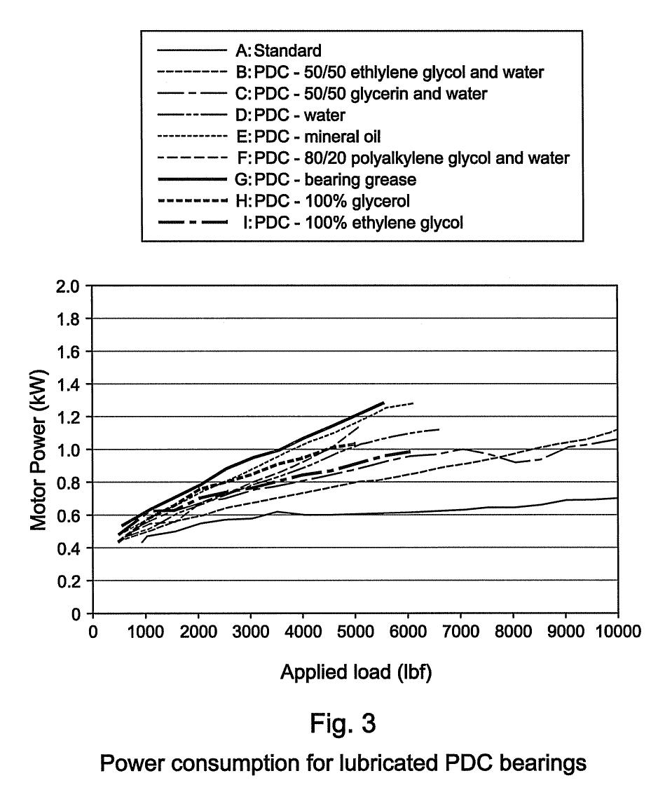

Laboratory tests have been conducted to demonstrate that a polyol lubricant provides an unexpectedly dramatic reduction in friction when in used in combination with diamond surfaces, particularly PCD surfaces. FIG. 3 is a graph of a series of tests run to indicate friction between two PCD test samples in sliding rotating contact with each other under an increasing load. A lower power consumption indicates a lower coefficient of friction. The standard steel bearing, having no diamond materials, exhibits the lowest coefficient of friction when used with a conventional, non glycol lubricant, as indicated by the curve A. The standard steel bearing had inlays of Stellite on one bearing surface and a coating of silver on the other. A PCD bearing lubricated with a mixture of 50% water and 50% ethylene glycol by volume (test B) or with a mixture of 50% glycerol and 50% water by volume (test C) result in significantly lower bearing friction and subsequent bearing temperature compared to that obtained on PCD bearings lubricated with water (test D), mineral oil (test E), 80% polyalkylene glycol with 20% water by volume (test F), or the standard bearing grease (test G). Test H illustrates a test using 100% glycerol, and Test I uses 100% ethylene glycol. In addition, differing mixtures with water and with combinations of polyols are feasible.

In the preferred embodiment, the lubrication system results in a coefficient of friction of less than 0.02 between the two diamond surfaces inside the diamond bearing system under high load and high speeds. This a marked improvement over the coefficients of friction achieved when either water or oil are used as a lubricant between two diamond surfaces in a high load, high speed environments. This dramatic reduction in friction with the present invention is believed to occur due to enhanced surface film formation on the diamond surface with these polyol fluids. Although the friction is not as low as with a grease lubricated steel bearing, the PCD bearing offers increased bearing life due to lower wear.

While the invention has been described in only one embodiment, it should be apparent to those skilled in the art that it is not so limited, but is susceptible to various changes without departing from the scope of the invention.

We claim:

1. A method for lubricating a diamond bearing system of a downhole well tool comprising:
dispensing a polyol lubricant for the reduction of friction between two diamond surfaces in a sealed diamond bearing system of a well tool.

2. The method of claim 1, wherein the well tool comprises an earth boring bit.

3. The method of claim 1, wherein the polyol lubricant is mixed with water.

4. The method of claim 1, wherein the polyol lubricant consists substantially of ethylene glycol, glycerol, or a combination thereof.

5. A down-hole drilling tool comprising:
a head section;
a bearing shaft extending from the head section;
an external region of the bearing shaft having a diamond contact surface;
a cutter rotatably mounting on the bearing shaft;
an internal region of the cutter having a diamond contact surface, the internal region of the cutter being in a sliding relationship with the external region of the bearing shaft; and
a sealed lubrication system for the reduction of friction between the external region of the bearing shaft and the internal region of the cutter, the sealed lubrication system comprising:
a lubricant comprising an organic compound having a minimum of two hydroxyl groups;
a seal assembly for retaining the lubricant in the lubrication system; and
a pressure compensator for reducing the pressure differential between the polyol lubricant and drilling fluid on the exterior of the drilling tool.

6. The drilling tool of claim 5, wherein the lubricant is mixed with water.

7. The drilling tool of claim 5, wherein the lubricant consists substantially of ethylene glycol, glycerol, or a combination thereof.

8. A downhole well tool comprising:
a sealed bearing system;
a rotating bearing surface having a diamond contact surface, a stationary bearing surface having diamond contact surfaces in sliding engagement with the rotating bearing surface; and
a polyol lubricant for the reduction of friction, wherein the polyol lubricant consists substantially of ethylene glycol, glycerol, or a combination thereof.

9. The drilling tool of claim 8, wherein the polyol lubricant is mixed with water.
